(19) United States
(12) Patent Application Publication
(10) Pub. No.: US 2010/0123325 A1
(43) Pub. Date: May 20, 2010

(54) PNEUMATICALLY CONTROLLED GRASPING DEVICE

(76) Inventor: Giuseppe Maffeis, Roncadelle (Brescia) (IT)

Correspondence Address: MCGLEW & TUTTLE, PC, P.O. BOX 9227, SCARBOROUGH STATION, SCARBOROUGH, NY, 10510-9227, US

(21) Appl. No.: 12/611,301

(22) Filed: Nov. 3, 2009

(30) Foreign Application Priority Data
Nov. 20, 2008 (IT) BS 2008 A 000209

(51) Int. Cl. B25J 15/00; B66C 1/42; B66C 1/44; B66C 1/54; B25J 15/02; B25J 15/08

(52) U.S. Cl. 294/88

(57) ABSTRACT

This invention concerns a pneumatically controlled grasping device to grasp and handle items or bodies provided with a graspable member. It comprises a supporting sleeve (16, 36) that internally delimits an intermediate space (23, 43) contiguous to a distal opening and a guide chamber (23′, 43′) connected to a source of fluid under pressure. In the intermediate space a gripper means (21, 41) is mounted, facing the distal opening and designed to engage with the graspable member. In the guide chamber a control piston (22, 42) is housed movable into a first position which corresponds to an activation or deactivation of the gripper means by the fluid under pressure, and to a second position which corresponds to the deactivation or activation of said gripper means, by at least a flexible reaction element (27, 47). The gripper means can be equipped to grasp the graspable member from the outside or from inside when it has a cavity.

### FIELD OF THE INVENTION

This invention concerns a pneumatically controlled grasping device to grasp, thrust and/or position items, bodies or tools or fixtures by any type of manipulator.

### STATE OF THE TECHNIQUE

Devices able to grasp and rapidly release an item or body to be handled by a robot or handling equipment, with the aim of reducing time and consequently operating or working costs in various sectors, such as presswork, robotics, automation and assembling, are already well known.

### OBJECTS AND SUMMARY OF THE INVENTION

An object of this invention is however to provide an innovative pneumatically controlled grasping device for use in the above mentioned range, simple to make and reliable, incorporating a gripper type grasping device for gripping an intermediate element preliminarily applied to the item, body or the like, which may be handled from the outside or inside, when hollow.

The object is achieved with a pneumatically controlled grasping device for grasping and handling items or bodies provided with a graspable member, comprising a support sleeve with at least a proximal connecting means to connect it to a manipulator and a fluid source, typically air, under pressure and a distal axial opening. The grasping device is characterized in that said sleeve forms an internal, intermediate space adjacent to said distal opening and a guide chamber connected to the fluid source under pressure, and in that in said intermediate space a gripper means is mounted facing the distal opening and designed to engage with said graspable member, and in said guide chamber a control piston is housed movable in a first position, corresponding to either a activation on or a deactivation of said gripper means by a fluid under pressure fed to said chamber, and in a second position which corresponds to either a deactivation or activation on of said gripper means by at least an elastic reaction element.

The dependent claims then refer to preferred and advantageous embodiments of some components of the device itself.

### BRIEF DESCRIPTION OF THE DRAWINGS

The invention will however be illustrated in detail in the course of the description carried out in reference to the enclosed exemplifying and not restrictive drawings, in which:

FIG. 1 is a exploded view of the components of a device for grasping a ball-grip from the outside;

FIG. 2 is a view in perspective of the device in FIG. 1 as assembled and connected to a ball-grip to be grasped;

FIG. 3 is a side view of the assembled device, but with the ball-grip to be grasped separated;

FIG. 4 is an axial section of the device according to arrows A-A in FIG. 3 with grasper jaws open;

FIG. 5 is a section analogous to the one in FIG. 4, but with the device in an intermediate grasping, or release, position, of a respective ball-grip;

FIG. 6 is a section analogous to the one in FIG. 5, but with the device in the grasping position of a respective ball-grip to be grasped;

FIG. 7 is a exploded view of the components of a device for grasping the inside of the hollow ball-grip;

FIG. 8 is a side view of the device in FIG. 7 as assembled with regard to a separated ball-grip to be grasped;

FIG. 9 is an axial section of the device according to arrows B-B in FIG. 3 in an inoperative position;

FIG. 10 is a side view of the device engaged to the hollow ball-grip; and

FIG. 11 shows an axial section according to arrows C-C in FIG. 10.

### DETAILED DESCRIPTION OF THE INVENTION

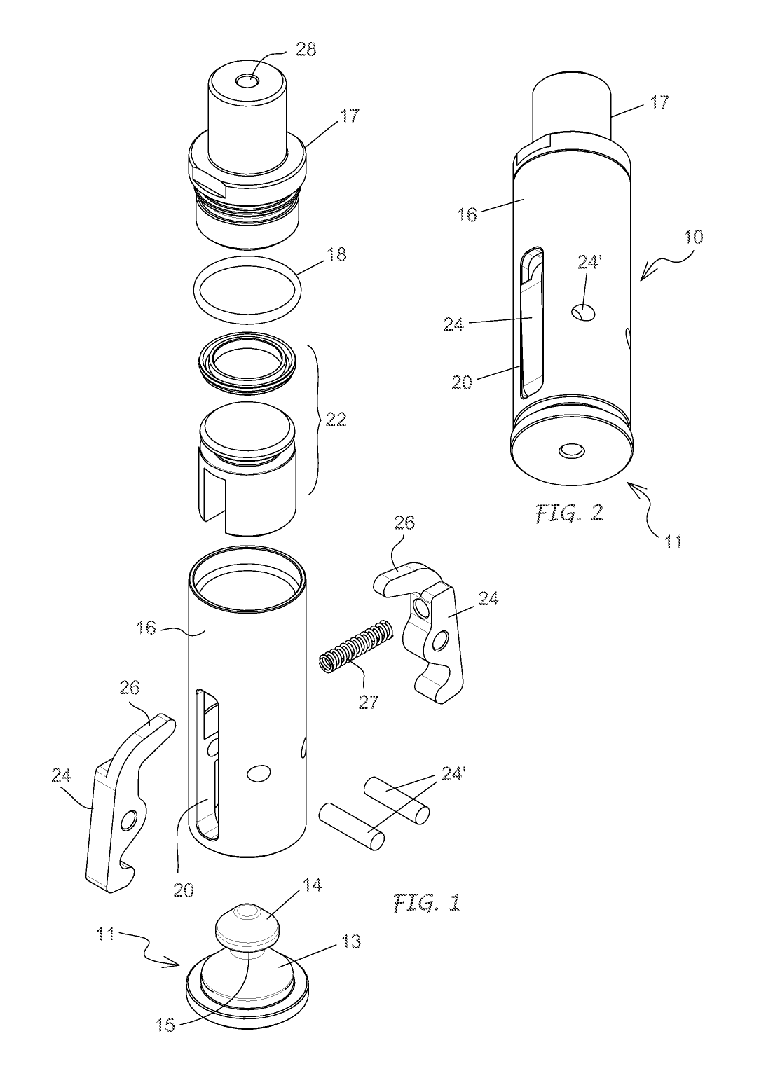

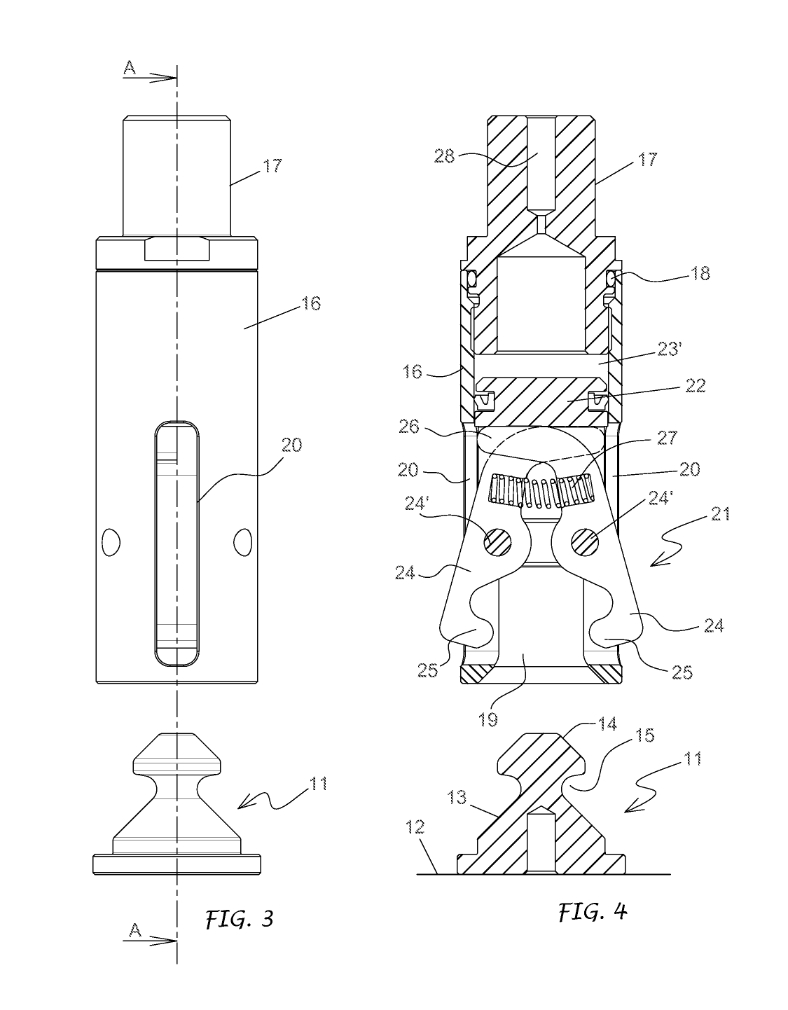

FIGS. 1-6 represent a grasping device 10 suitable for gripping from the outside, for example, a graspable ball-grip 11 preliminarily fixed to an item or a body 12 to be handled and/or positioned. This ball-grip 11 has a tapered leg 13 overhung mushroom like by a head 14 also tapered, delimiting between them a peripheral graspable groove 15.

The grasping device 10 comprises a supporting sleeve 16, basically cylindrical, having a proximal end to which a fitting 17 is screwed with the interposition of a seal 18, a distal end with an axial opening 19 and, laterally, two longitudinal slots 20 on opposite sides.

Internally, the supporting sleeve 16 is provided with a gripper means 21 and a control piston 22 associated therewith. The gripper means 21 is positioned in an intermediate space 23 of the sleeve 16 on a level and in line with the lateral slots 20, whereas the piston 22 is housed and movable in a guide chamber 23′ delimited by the supporting sleeve 16 at a level between the proximal fitting 17 and said intermediate space 23.

The gripper means 21 is made up of two complementary gripper arms 24, each assembled and oscillating on a respective pin 24′. Each arm of the gripper 24 has a terminal gripper nose 25 opposite to the one of the other arm, the gripper noses being in the vicinity of the distal opening 19 of the supporting sleeve 16 and configured depending on the shape of the groove 15 around the graspable ball-grip 12. At the opposite end of the one provided with a gripper nose 25, each gripper arm 24 has an extension or appendix 26 facing towards and in contact with the control piston 22 through a slot at the base of the latter. Between the two gripper arms 24 a spring 27 is positioned, designed to maintain the terminal gripper noses 25 close to one another in an operating grasping position and to move and maintain the control piston 22, by means of the extensions or appendixes 26, in a retracted position towards the proximal fitting 17. The piston 22, however, is moveable forwards towards the gripper means 21 by a fluid under pressure, typically air, fed to the chamber 23 through a hole 28 made in the proximal fitting 17 so as to cause, through the extension or appendix 26 of the gripper arms 24, the terminal gripper noses 25 to move away and therefore open the gripper means.

The proximal fitting 17 usually also acts as a means for forming a rigid connection of the grasping device 10 to any manipulator member or equipment—not shown.

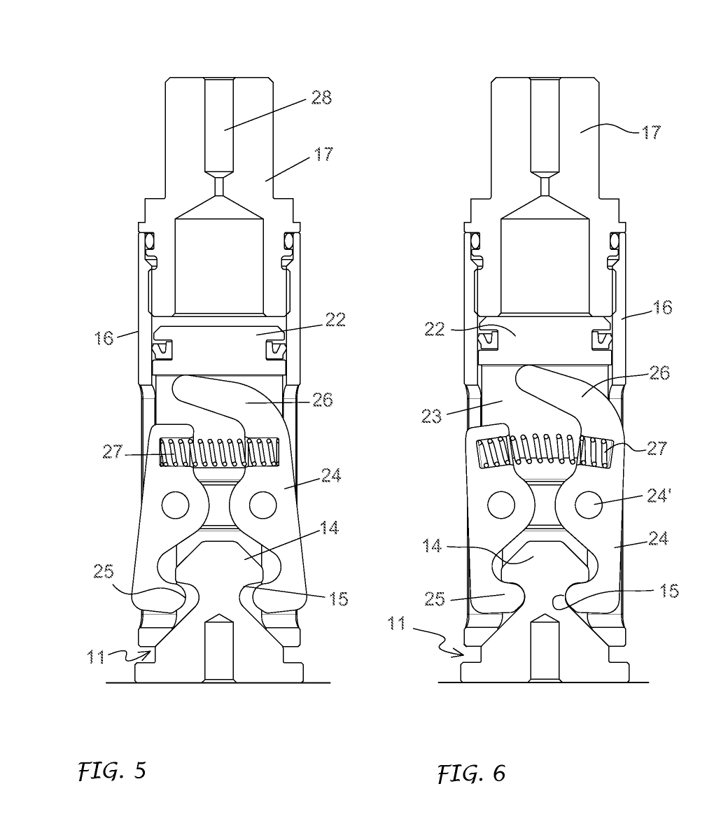

Practically, therefore, the gripper means 21, thanks to the relative spring 27, normally remains in the active position, that is to say closed, whereas the control piston 22 remains in a retracted position. However when the device is moved near the graspable ball-grip 11, the gripper noses 25 of the gripper arms 24 in contact with the tapered head 14 of said ball-grip open wide first—FIG. 5—then close automatically in the groove 15, grasping in this way the ball-grip—FIG. 6—and, by means of this, the item or body 12 the ball-grip has been fixed to. In this way the item or body 12 involved, not only will it be grasped and conveniently handled, but also may pulled and pushed, consequently positioned according to needs with regards to a preset “zero” position, by means of an appropriate management of the movements of the device or manipulator carrying the grasping device.

Then, to release the graspable ball-grip 11 and with it the item or body 12 it is associated with, it is sufficient to supply the fluid under pressure to the chamber 23′ in order to move the control piston 22 forward and cause the gripper arms to turn and therefore the opening of the gripper means in opposition to the spring 27 as shown in FIG. 4.

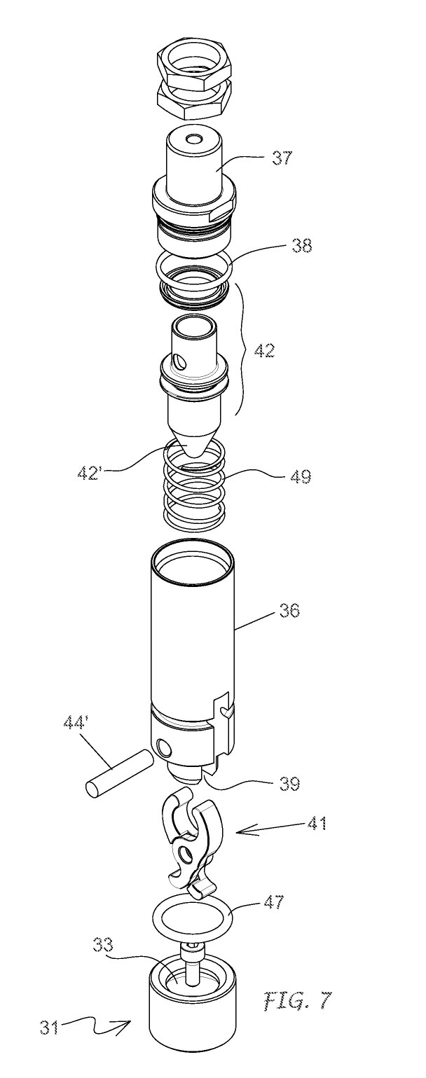

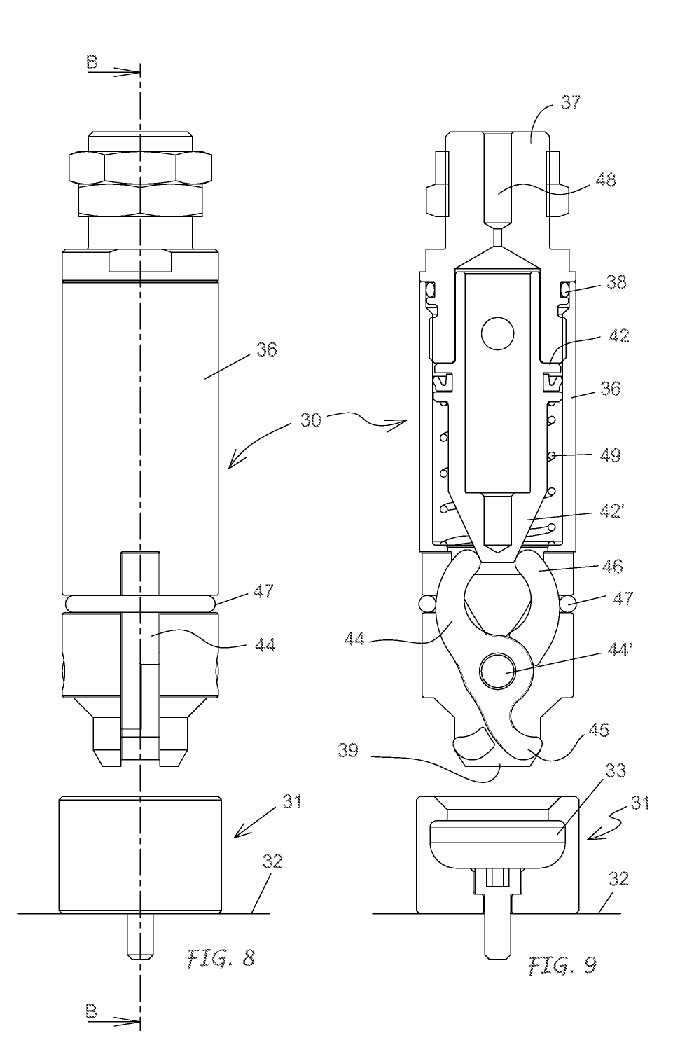

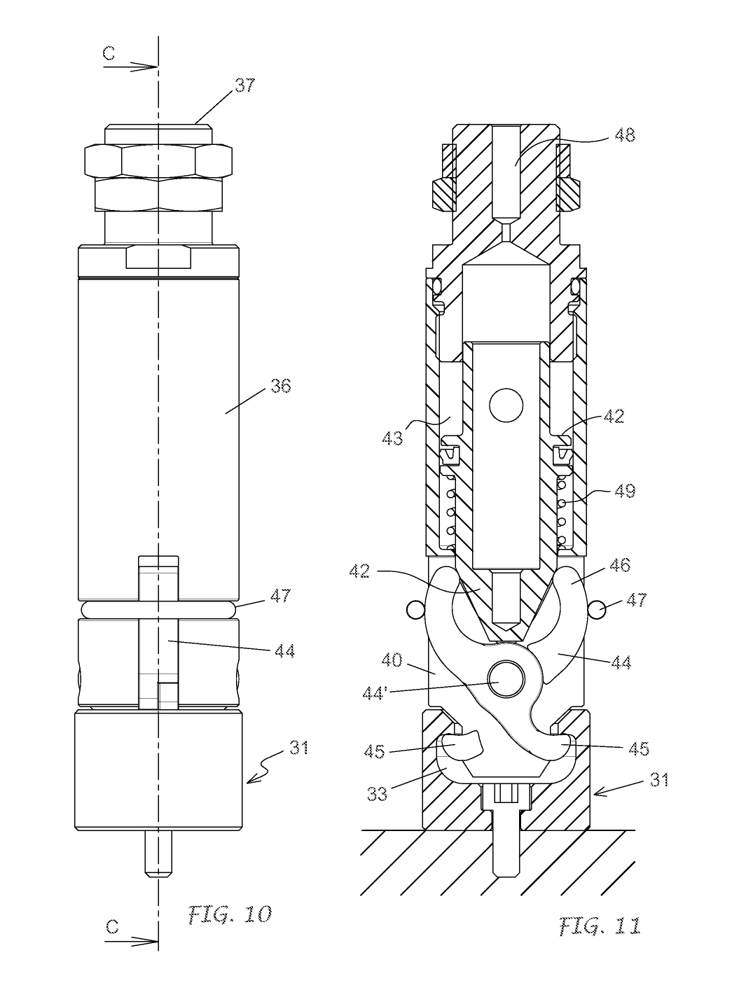

According to the embodiment of FIGS. 7-11, the grasping device 30 is suitable on the contrary to grasp a ball-grip 31 from the inside, fixed in advance to an item or a body 32 to handle and/or position it and having in this case a front graspable groove 33.

The grasping device 30 comprises a basically cylindrical supporting sleeve 36, having a proximal end to which a fitting 37 is screwed with the interposition of a seal 38, a distal tapered end with an opening 39 and, laterally, two longitudinal slots 40 on opposite parts. Internally, the supporting sleeve 36 holds a gripper means 41 and a control piston 42 associated therewith. The gripper means 41 is positioned in an intermediate space 43 on a level and in line with the lateral slots 40, whereas the piston 42 is housed and slides in a chamber 43′ delimited by the supporting sleeve 36 at a level between the proximal fitting 37 and said lateral slots 40.

In this case, the gripper means 41 is made up of two crossed gripper arms 44, assembled and turning on a common pin 44′ and each one having a terminal gripper nose 45. The gripper noses are facing in opposite directions, towards the outside, near the distal opening 39 of the supporting sleeve 36 and configured to be able to fit in the cavity 33 of the graspable ball-grip 31.

From the opposite part of their gripper noses 45, the gripper arms 44 each have an extension or appendix 46 facing towards and in contact with the control piston 42. In one groove around the supporting sleeve 36 is mounted a flexible ring 47, which engages with the gripper arms 44 so as to normally maintain their terminal gripper noses 45 near to each other in a released idle position and to maintain the extensions or appendixes 46 of said gripper arms in contact with the piston 42.

The control piston 42 has a conical portion 42′ that comes between the extensions and appendixes 46 of the gripper arms 44 to control the activation and deactivation of the latter with the help of the external flexible ring 47 and depending on the position of the piston in the guide chamber 43′. A spring 49 associated with the piston 42 works so as to maintain it in a retracted position towards the proximal fitting 37, a position that corresponds to the release condition of the gripper means on the part of the flexible ring 47 engaging with gripper arms. Furthermore, the piston 42 can move forward towards the gripper means 41 by the fluid under pressure, typically air, fed to the chamber 43′ through a hole 48 made in the proximal fitting 37 so as to cause, by means of its conical portion 42′ the opening of the extensions or appendixes of the gripper arms and consequently a grasper action on the part of the gripper noses 45.

Respectively, as long as the control piston 42 is in the retracted position, the gripper means 41 remains in an idle position as in FIG. 9. Once the coupling device 30 has been drawn near the graspable ball-grip 41 by any manipulator, the gripper means can be activated by feeding the fluid under pressure to the chamber 43′ so as to move the piston 42 forward and cause, by its conical portion 42′, the rotation of the gripper arms in that their gripper noses 45, by distancing themselves one from the other, engage inside the cavity 33 of said ball-grip 42 as shown in FIG. 11.

The, to release the hollow ball-grip 41 and with it the item or body 42 it is associated with, it is sufficient to remove the fluid under pressure from the chamber 43′. The return spring 48 will now push the piston back, while the flexible external ring 47 will return the gripper means to the idle starting position.

1. Pneumatically controlled grasping device for grasping and handling items or bodies provided with a graspable member, comprising a support sleeve with at least a proximal connecting means to connect it to a manipulator and a fluid source, typically air, under pressure and a distal axial opening, characterized in that said sleeve (16, 46) forms an internal, intermediate space (23, 43) adjacent to said distal opening and a guide chamber (23′, 43′) connected to the fluid source under pressure, and in that in said intermediate space a gripper means (21,41) is mounted facing the distal opening and designed to engage with said graspable member, and in said guide chamber a control piston (22, 42) is housed movable in a first position, corresponding to either an activation on or a deactivation of said gripper means by a fluid under pressure fed to said chamber, and in a second position which corresponds to either a deactivation or activation on of said gripper means by at least an elastic reaction element (27, 47).

2. Grasping device according to claim 1, wherein the graspable member (11) has a truncated cone shank dominated by a head which is also truncated cone shape to form between them a circular peripheral groove (15), characterized in that said gripper means (21) is set up to engage from the outside in the peripheral groove of said graspable member when the gripper means is in an active position.

3. Grasping device according to claim 2, characterized in that said gripper means (21) comprises two complementary gripper arms (24) each oscillating on a respective pin, where each gripper arm has, on one side, a terminal gripper nose (25) opposite to that of the other arm and adjacent to the distal opening of the supporting sleeve and, on the opposite side, an extension or appendix (26) facing towards and in contact with the control piston (22).

4. Grasping device according to claim 3, characterized in that the elastic reaction element is a spring (27) placed between the gripper arms (24) to hold said terminal gripper noses (25) normally close together in an active grip position and to move the control piston (22) into a retracted position towards the proximal connection means, and in that said piston (22) is moved by a fluid under pressure towards the extensions or appendixes of the gripper arms causing the gripper means to switch off.

5. Grasping device according to claim 1, wherein the graspable member (31) is provided with a front gripper cavity (33), characterized in that said gripper means (41) is set up to connect inside said front cavity of the graspable member when the gripper means is in the active position.

6. Grasping device according to claim 5, characterized in that said gripper means (41) comprises two crossed gripper arms (44), assembled and turning on a common pin, wherein each gripper arm has, on one side, a terminal gripper nose (45) adjacent to the distal opening of the support sleeve (36) and, on the opposite side, an extension or appendix (46), said gripper noses (45) facing in opposite directions towards the outside, whereas the opposite extensions or appendixes are facing towards and in contact with the control piston (42).

7. Grasping device according to claim 5, characterized in that a flexible ring (47) is located around the supporting sleeve (36) and engaging with the gripper arms (44) so as to keep the terminal gripper noses (45) close to one another in an idle gripper position and the extensions or appendixes (46) of said gripper arms in contact with the piston (42), and in that the piston (42) has a conical portion (42′) in contact with said extensions or appendixes so as to cause the gripper arms to turn and the activation of the gripper means when the piston is moved in one direction by the fluid under pressure, and the deactivation of the gripper means when the piston is moved in the opposite direction by a return spring (49) associated with it.

8. Grasping device according to claim 1, characterized in that the gripper arms (24, 44) are in line with longitudinal splits or slots (20, 40) provided on opposite sides of the supporting sleeve (16, 36).

9. Grasping device according to claim 1, characterized in that the proximal connecting means is made up of a fitting with a portion fixed to a manipulator, and at least a fluid under pressure feed bore to the guide chamber of the piston.
